(19) United States
(12) Patent Application Publication
(10) Pub. No.: US 2025/0148610 A1
(43) Pub. Date: May 8, 2025

(54) OBJECT SEGMENTATION METHOD AND APPARATUS, DEVICE AND STORAGE MEDIUM

(71) Applicant: Beijing Zitiao Network Technology Co., Ltd., Beijing (CN)

(72) Inventor: Yuanlue ZHU, Beijing (CN)

(21) Appl. No.: 18/833,826

(22) PCT Filed: Jan. 16, 2023
(86) PCT No.: PCT/CN2023/072337

§ 371 Date: Jul. 26, 2024

(30) Foreign Application Priority Data
Jan. 28, 2022 (CN) 202210107771.5

(51) Int. Cl. G06T 7/162; G06T 7/90; G06V 10/88

(52) U.S. Cl. CPC G06T 7/162; G06T 7/90; G06V 10/88; G06T 2207/10024; G06T 2207/20112

(57) ABSTRACT

Embodiments of the present disclosure disclose an object segmentation method and apparatus, a device and a storage medium. The method comprises: obtain an initial mask graph by performing semantic recognition on a target object in an image to be segmented; determining an initial target object area in the image to be segmented based on the initial mask graph; obtaining N color classifications of the target object by performing clustering processing on pixel points in the initial target object area according to color values; obtaining N difference graphs according to the N color classifications and the image to be segmented; determining a target mask graph according to the N difference graphs and the initial mask graph; and segmenting the target object in the image to be segmented based on the target mask graph.

The present application claims a priority right to the Chinese patent application No. 202210107771.5 filed on Jan. 28, 2022 with the Chinses Patent Office, the entire disclosure of which is hereby incorporated by reference in its entirety.

### FIELD

Embodiments of the present disclosure relate to the field of image processing technologies, for example to an object segmentation method and apparatus, a device and a storage medium.

### BACKGROUND

Currently, there are the following two implementation methods for sky segmentation: one is segmenting the sky by using a deep learning algorithm of a convolution neural network, the method causing a case in which partial missing segmentation occurs in the middle of the segmented mask graph; the other is segmenting the sky by using a traditional algorithm based on color information, this method relying on the color of the sky and possibly leading to mis-segmentation. Failure might occur with pictures with small color differences.

### SUMMARY

Embodiments of the present disclosure provide an object segmentation method, apparatus, device, and storage medium to achieve segmentation of an object in an image, prevent missing segmentation of the object, and improve accuracy of object segmentation.

In a first aspect, embodiments of the present disclosure provide an object segmentation method comprising:
obtaining an initial mask graph by performing semantic recognition on a target object in an image to be segmented;
determining an initial target object area in the image to be segmented based on the initial mask graph;
obtaining N color classifications of the target object by performing clustering processing on pixel points in the initial target object area according to color values, wherein N is a positive integer greater than or equal to 1;
obtaining N difference graphs according to the N color classifications and the image to be segmented;
determining a target mask graph according to the N difference graphs and the initial mask graph; and
segmenting the target object in the image to be segmented based on the target mask graph.

In a second aspect, embodiments of the present disclosure also provide an object segmentation apparatus, comprising:
an initial mask graph obtaining module configured to obtain an initial mask graph by performing semantic recognition on a target object in an image to be segmented;
an initial target object area determining module configured to determine an initial target object area in the image to be segmented based on the initial mask graph;
a clustering module configured to obtain N color classifications of the target object by performing clustering processing on pixel points in the initial target object area according to color values, wherein N is a positive integer greater than or equal to 1;
a difference graph obtaining module configured to obtain N difference graphs according to the N color classifications and the image to be segmented;
a target mask graph obtaining module configured to determine a target mask graph according to the N difference graphs and the initial mask graph; and
an image segmenting module configured to segment the target object in the image to be segmented based on the target mask graph.

In a third aspect, embodiments of the present disclosure further provide an electronic device comprising:
one or more processing means;
a storage means configured to store one or more programs;
the one or more programs, when executed by the one or more processing means, cause the one or more processing means to implement the object segmentation method as described in embodiments of the present disclosure.

In a fourth aspect, embodiments of the present disclosure also provide a computer-readable medium having stored thereon a computer program which, when executed by a processing means, implements an object segmentation method as described in embodiments of the present disclosure.

### BRIEF DESCRIPTION OF THE DRAWINGS

FIG. 1 is a flow chart of an object segmentation method in an embodiment of the present disclosure;

FIG. 2a is an example diagram of an image to be segmented in an embodiment of the present disclosure;

FIG. 2b is an exemplary diagram of an initial mask graph in an embodiment of the present disclosure;

FIG. 2c is an exemplary diagram of a difference graph in an embodiment of the present disclosure;

FIG. 2d is an exemplary diagram of a target mask graph in an embodiment of the present disclosure;

FIG. 2e is a visualization image generated based on the initial mask graph in an embodiment of the present disclosure;

FIG. 2f is a visualization image generated based on a target mask graph in an embodiment of the present disclosure;

FIG. 3 is a schematic diagram of an object segmentation apparatus in an embodiment of the present disclosure.

FIG. 4 is a block diagram of an electronic device according to an embodiment of the present disclosure.

### DETAILED DESCRIPTION OF EMBODIMENTS

It should be appreciated that steps described in a method embodiment of the present disclosure may be performed in a different order and/or in parallel. In addition, the method embodiment may include additional steps and/or omit performing the steps shown. The scope of the present disclosure is not limited in this respect.

As used herein, the term “comprises” and variations thereof are open-ended terms, i.e., mean “comprise, but not limited to”. The term “based on” means “based, at least in part, on”. The term “one embodiment” means “at least one embodiment”; the term “another embodiment” means “at least one further embodiment”; the term “some embodiments” means “at least some embodiments”. Relevant definitions of other terms will be given in the following depictions herein.

It needs to be appreciated that concepts such as “first” and “second” mentioned in the present disclosure are only used to distinguish between different devices, modules, or units and are not intended to limit the order of functions performed by these devices, modules or units or interdependence thereof.

It needs to be appreciated that the modifiers “one” or “more” mentioned in the present disclosure are intended to be illustrative and not restrictive, and those skilled in the art will understand that such modifiers should be understood as “one or more” unless the context clearly indicates otherwise.

The names of messages or information interacted between devices in embodiments of the present disclosure are for illustrative purposes only and are not intended to limit the scope of such messages or information.

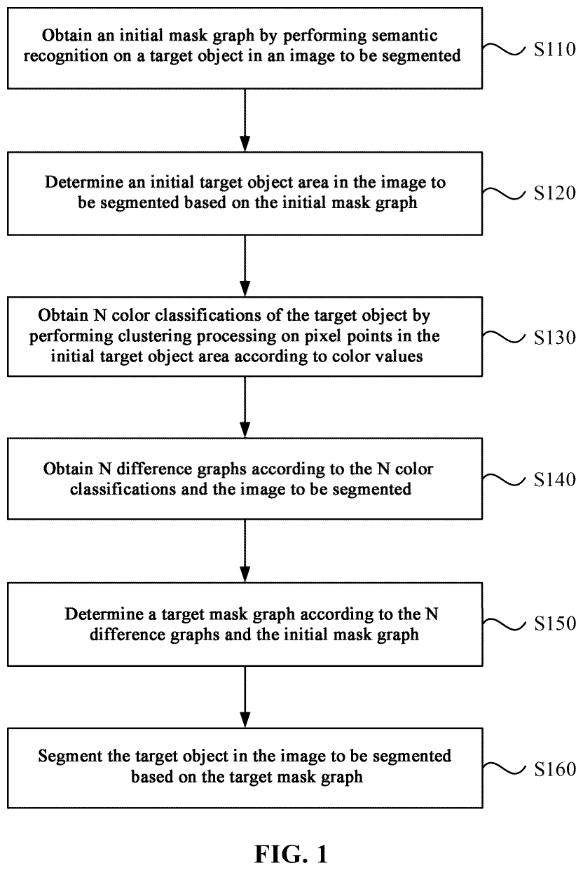

FIG. 1 is a flow chart of an object segmentation method according to an embodiment of the present disclosure. The embodiment may be adapted for the case of segmenting a target object in an image. The method may be performed by an object segmentation apparatus. The apparatus may comprise hardware and/or software and may be generally integrated in a device having an object segmentation function. The device may be an electronic device such as a server, a mobile terminal or a server cluster. As shown in FIG. 1, the method comprises the following steps:
Step 110: obtaining an initial mask graph by performing semantic recognition on a target object in an image to be segmented.

The target object may need any object segmented from the image, for example: a vehicle, a tree, a buildings, sky, etc. In the present embodiment, the segmentation is mainly for “sky”. The size of the initial mask graph is the same as that of the image to be segmented, and a gray value of each pixel point represents a confidence that the pixel point belongs to the target object. For example, the semantics of each pixel point of the image to be segmented are recognized, the confidence that each pixel point belongs to the target object is determined, and the grey value of each pixel point is determined according to the confidence, so as to obtain the initial mask graph. Illustratively, assuming that the confidence that a pixel belongs to the target object is 200/255, the gray value of the pixel is set to 200.

For example, a process of obtaining an initial mask graph by performing semantic recognition on a target object in an image to be segmented may be inputting the image to be segmented into a target object recognition model, and outputting the initial mask graph.

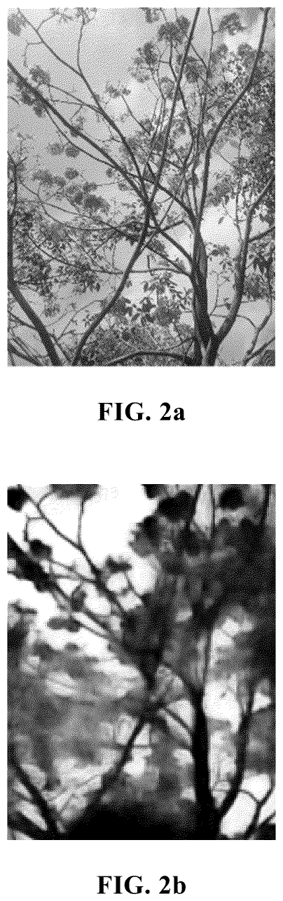

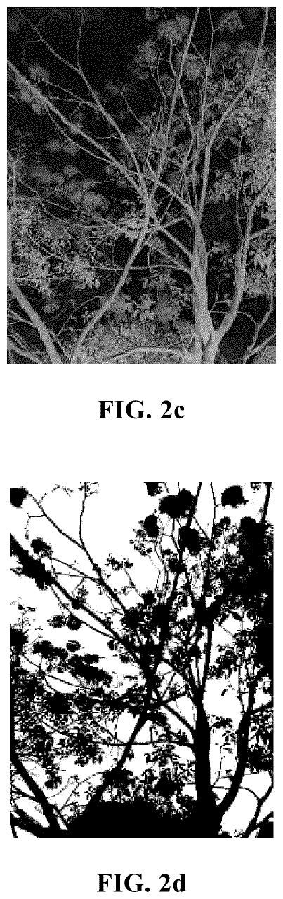

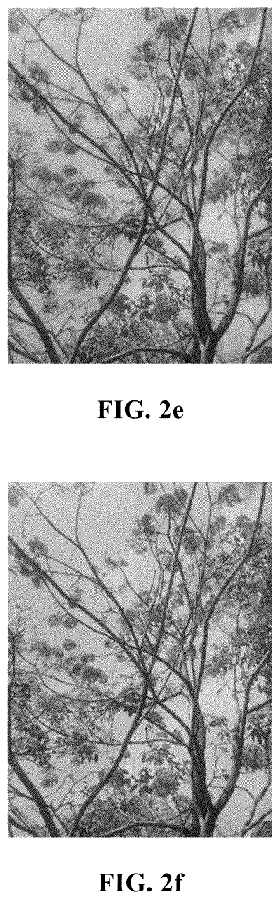

The target object recognition model may be obtained by training a neural network model with image segmentation data. The image to be segmented is input into the target object recognition model, and the confidence that each pixel point belongs to the target object is output so as to obtain the initial mask graph. Exemplarily, FIG. 2a shows the image to be segmented (the original image is a color image) and FIG. 2b shows the initial mask graph. FIG. 2b shows a mask graph obtained after “sky” recognition is performed on FIG. 2a. The closer the gray scale is to white, the greater the probability that the pixel point is “sky”. In the present embodiment, the recognition of the target object is performed by the target object recognition model, to improve the recognition accuracy and efficiency of the target object.

Step 120: determining an initial target object area in the image to be segmented based on the initial mask graph.

The initial target object area may be understood as an area formed of the target object determined according to the initial mask graph.

For example, a manner of determining the initial target object area in the image to be segmented based on the initial mask graph may be: obtaining a pixel point in the initial mask graph with a confidence greater than a first set value, and determining the pixel point as a first target point; determining an area formed of a pixel point corresponding to the first target point in the image to be segmented, as the initial target object area.

The first set value may be any value between 180/255−220/255. For example, a pixel point in the initial mask pattern with a confidence greater than the first set value is determined as a first target point, which indicates that the probability that the pixel point corresponding to the first target point in the image to be divided belongs to the target object is greater than the first set value, and therefore the area formed of the pixel point corresponding to the first target point in the image to be segmented is determined as the initial target object area. In the present embodiment, the area surrounded by pixel points with a confidence greater than the first set value is determined as the initial target object area, and the target object may be roughly segmented first.

Step 130: obtaining N color classifications of the target object by performing clustering processing on pixel points in the initial target object area according to color values,
where N is a positive integer greater than or equal to 1, for example, N takes 3, then pixel points in the initial target object area may be clustered into three classes according to color values. For example, after the initial target object area is obtained, a color value (Red Green Blue, RGB) of each pixel point in the initial target object area is obtained, and clustering of N classifications in the initial target object area is performed according to the color values, thereby obtaining pixel points in the N color classification of the target object. In the present embodiment, any clustering algorithm in the related art may be used to perform clustering processing on the pixel points in the initial target object area, and is not limited herein.

Step 140: obtaining N difference graphs according to the N color classifications and the image to be segmented.

The difference graph may be an image obtained by obtained a difference between the image to be segmented with a certain color value. For example, the color value of each pixel point in the segmentation image is obtained, and then the certain color value is subtracted from the color value of each pixel point to obtain a post-subtraction color value of the each pixel point, thereby obtaining a difference graph. Obtaining the difference between color values may be understood as obtaining a difference between color values in RBG three channels, respectively.

For example, the process of obtaining N difference graphs according to the N color classifications and the image to be segmented may be: calculating an average value for N color classes, respectively, to obtain N color average values; calculating differences between the image to be segmented and N color average values, respectively, to obtain N difference graphs.

Here, calculating an average value for each color classification may be understood as calculating an average value for the RGB three channels in each color classification. In the present embodiment, after N classification is performed for the pixel points in the initial target object area, the color values of the pixel points included in each classification are extracted, and then the color values are averaged to obtain N color average values, and then differences between the image to be segmented and the N color average values are obtained respectively to obtain N difference graphs. Exemplarily, FIG. 2c is an exemplary diagram of a difference graph in the present embodiment. As shown in FIG. 2c, the color of each pixel point in the image is a value obtained by subtracting the color average value from the color of the pixel point in the original image. In the present embodiment, obtaining N difference graphs by obtaining differences between the image to be segmented with N color average values may improve the speed of obtaining the difference graphs.

Step 150: determining a target mask graph according to the N difference graphs and the initial mask graph.

The target mask graph may be a mask graph after the initial mask graph is optimized. For example, the confidences of a plurality of pixel points in the initial mask graph may be adjusted based on the N difference graphs to obtain a target mask graph.

For example, the process of determining the target mask graph according to the N difference graphs and the initial mask graph may be: adjusting a confidence of a pixel points in the initial mask graph with a confidence falling into a first interval, to a first set confidence value; for a pixel point in the initial mask graph with a confidence falling into a second interval, increasing the confidence of the pixel point by a set proportion in response to determining that a color value of the pixel point in N difference graphs meets a set condition, and decreasing the confidence of the pixel point by the set proportion in response to determining that the color value of the pixel point in the N difference graphs does not meet the set condition; adjusting the confidence of a pixel point in the initial mask graph with a confidence falling into a third interval, to a second set confidence value.

The first interval is greater than the first set value and less than the first set confidence value; the second interval is greater than the second set value and less than the first set value; the second set value is less than the first set value; the third interval is greater than the second set confidence value and less than the second set value. Exemplarily, assuming that the first set point is set to 200/255, the first set confidence value is 1, the second set value is set to 40/255, the second set confidence value, the first interval is [200/255, 255/255), the second interval is [40/255, 200/255), and the third interval is [0, 40/255). The setting condition may be: the average value of the color values of the pixel points in the N difference graphs is less than a set threshold value; or a minimum value of the color values of the pixel points in the N difference graphs is less than a set threshold value.

In the present embodiment, the pixel points in the mask graph correspond one to one with the pixel points in the difference graph, and the color values of the pixel points in the N difference graphs may be understood as the color values of the corresponding pixel points in the N difference graphs. The average value of the color values less than the set threshold value may be understood that the average value of the colors of the RGB three channels is less than the set threshold value. Here, the set threshold value may be set to any value in a range of 30 to 50, for example, 40. Exemplarily, for a pixel, in response to determining that color values of pixels in the N difference graphs corresponding to the pixel are (R1, G1, B1), (R2, G2, B2), . . . , (RN, GN, BN), respectively, the average value of the color values of the pixel in the N difference graphs is (R1+R2+ . . . +RN)/N, (G1+G2+ . . . +GN)/N, (B1+B2+ . . . +BN)/N). Likewise, the minimum value of the color values of the pixel points in the N difference graphs less than the set threshold value may be understood in a way that the minimum value of the color values in the FBG three channels is less than the set threshold value.

Increasing the set proportion may be understood as enlarging the confidence by a multiple corresponding to the set proportion, and decreasing the set proportion may be understood as decreasing the confidence by a multiple corresponding to the set proportion. Exemplarily, assuming that the set proportion is m and the confidence is A, the confidence increased by the set proportion is expressed as A*m, and the confidence decreased by the set proportion is expressed as A/m.

For example, for a pixel with a confidence falling into [200/255, 255/255), the confidence of this pixel is directly adjusted to 255/255. For a pixel point with a confidence falling within [40/255, 200/255) in the initial mask graph, the confidence of the pixel point is increased by the set proportion in response to determining that the average value of the color values of the pixel point in the N difference graphs is less than the set threshold value, or the minimum value of the color values of the pixel point in the N difference graphs is less than the set threshold value; the confidence of the pixel point is decreased by the set proportion in response to determining that the average of the color values of the pixel point in the N difference graphs is greater than or equal to the set threshold value and the minimum value of the color values of the pixel point in the N difference graphs is greater than or equal to the set threshold value. For a pixel with a confidence falling into [0, 40/255), the confidence of this pixel is directly adjusted to 0. Exemplarily, FIG. 2d is an exemplary view of the target mask graph in the present embodiment. As shown in FIG. 2d, the boundary of the target object with other areas is more obvious. In the present embodiment, the confidences of a plurality of pixel points in the initial mask graph are adjusted to 0 or 255/255 according to the initial confidences and N difference graphs, so that the boundary between the target object and other areas in the mask graph is more obvious, thereby improving the segmentation accuracy of the target object.

For example, after increasing the confidence of the pixel point by the set proportion, the method further comprises setting the pixel point to the first set confidence value in response to determining that the increased confidence exceeds the first set confidence value. This may ensure that the pixel points in the mask are in the interval [0, 255/255].

Step 160: segmenting the target object in the image to be segmented based on the target mask graph.

The target mask graph characterizes the confidence that a plurality of pixel points belong to the target object, and the target object may be segmented according to the confidence.

For example, the process of segmenting the image to be segmented based on the target mask graph may be: determining a pixel point in the target mask graph with a confidence being the first set confidence value as a second target point; determining an area formed by a pixel point in the image to be segmented corresponding to the second target point, as a final target object area.

The first set confidence value is 255/255. For example, a pixel point in the target mask graph with a confidence being a first set confidence value is determined as the second target point, which indicates that a probability that a pixel point in the image to be segmented corresponding to the second target point is 255/255. Therefore, an area formed by the pixel point in the image to be segmented corresponding to the second target point is determined as the final target object area. Exemplarily, FIG. 2e is a visualization image generated based on the initial mask graph (the original image is a color image), and FIG. 2f is a visualization image generated based on the target mask graph (the original image is a color image). As can be seen from the figures, the segmentation boundary of “sky’ from other areas is more obvious in FIG. 2f than in FIG. 2e. In the present embodiment, the target object may be accurately segmented by determining the area surrounded by the pixel points with the confidence being the first set confidence, as the final target object area.

According to the technical solution of the present disclosure, semantic recognition is performed on a target object in an image to be segmented, to obtain an initial mask graph; an initial target object area in the image to be segmented is determined based on the initial mask graph; clustering processing is performed on pixel points in the initial target object area according to color values, to obtain N color classifications of the target object; N difference graphs are obtained according to the N color classifications and the image to be segmented; a target mask graph is determined according to the N difference graphs and the initial mask graph; the image to be segmented is segmented based on the target mask graph. The object segmentation method according to the embodiments of the present disclosure may achieve segmentation of an object in the image, prevent missing segmentation of an object, and improve the accuracy of object segmentation by determining a target mask graph according to the difference graph and the initial mask graph, and thereby segmenting a target object in the image to be segmented based on the target mask graph.

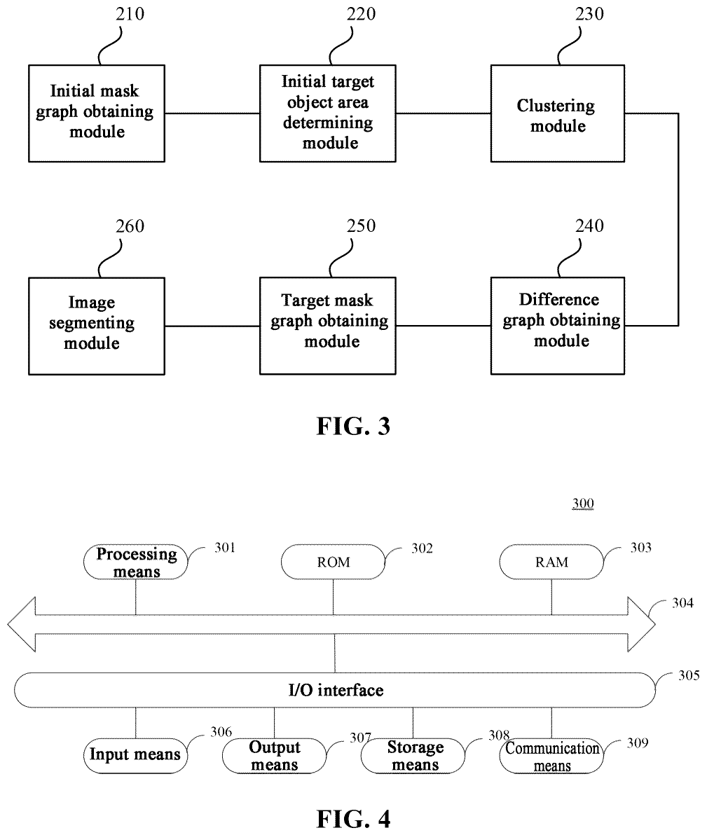

FIG. 3 is a schematic structural diagram of an object segmentation apparatus according to an embodiment of the present disclosure. As shown in FIG. 3, the apparatus comprises:
an initial mask graph obtaining module 210 configured to obtain an initial mask graph by performing semantic recognition on a target object in an image to be segmented;
an initial target object area determining module 220 configured to determine an initial target object area in the image to be segmented based on the initial mask graph;
a clustering module 230 configured to obtain N color classifications of the target object by performing clustering processing on pixel points in the initial target object area according to color values, wherein Nis a positive integer greater than or equal to 1;
a difference graph obtaining module 240 configured to obtain N difference graphs according to the N color classifications and the image to be segmented;
a target mask graph obtaining module 250 configured to determine a target mask graph according to the N difference graphs and the initial mask graph; and
an image segmenting module 260 configured to segment the target object in the image to be segmented based on the target mask graph.

For example, the initial mask graph obtaining module 210 is further configured to:
input the image to be segmented into a target object recognition model, and output the initial mask graph.

For example, the initial target object area determining module 220 is further configured to:
obtain a pixel point in the initial mask graph with a confidence greater than a first set value, and determine the pixel point with the confidence greater than the first set as a first target point; and
determine an area formed of pixel points in the image to be segmented corresponding to the first target point as an initial target object area.

For example, the difference graph obtaining module 240 is further configured to:
obtain N color average values by calculating average values for the N color classifications respectively; and
obtain the N difference graphs by calculating differences between the image to be segmented and the N color average values respectively.

For example, the target mask graph obtaining module 250 is further configured to:
adjust a confidence of a pixel point in the initial mask graph with a confidence falling into a first interval to a first set confidence value, wherein the first interval is greater than the first set value and less than the first set confidence value;
for a pixel point in the initial mask graph with a confidence falling into a second interval, increasing the confidence of the pixel point by a set proportion in response to determine that a color value of the pixel point in the N difference graphs meets a set condition, and decrease the confidence of the pixel point by the set proportion in response to determining that the color value of the pixel point in the N difference graphs does not meet the set condition, wherein the second interval is greater than a second set value and less than the first set value, and the second set value is less than the first set value;
adjust a confidence of a pixel point in the initial mask graph with a confidence falling into a third interval to a second set confidence value, wherein the third interval is greater than the second set confidence value and less than the second set value.

For example, the target mask graph obtaining module 250 is further configured to:
set the pixel point to the first set confidence value in response to determining that the increased confidence exceeds the first set confidence value.

For example, the image segmenting module 260 is further configured to:
determine a pixel point in the target mask graph with a confidence being the first set confidence value as a second target point; and
determine an area formed by a pixel point in the image to be segmented corresponding to the second target point as a final target object area.

The apparatus described above may perform the methods provided by all of the previously described embodiments of the present disclosure, and has corresponding functional modules and advantageous effects of performing the methods described above. Details not described in detail in the present examples may be found in the methods provided in all of the foregoing embodiments of the present disclosure.

Referring now to FIG. 4, a block diagram of an electronic device 300 suitable for implementing embodiments of the present disclosure is shown. The electronic devices in the embodiments of the present disclosure may include, but are not limited to, a mobile terminal such as a mobile phone, a notebook computer, a digital broadcast receiver, a PDA (Personal Digital Assistant), a PAD (Tablet Computer), a PMP (Portable Multimedia Player), an in-vehicle terminal (e.g., an in-vehicle navigation terminal), and a fixed terminal such as a digital TV, a desktop computer, etc. or various forms of servers such as a stand-alone server or a server cluster. The electronic device shown in FIG. 4 is merely an example and should not impose any limitations on the functionality and scope of use of embodiments of the present disclosure.

As shown in FIG. 4, the electronic device 300 may comprises a processing means (e.g., a central processor, a graphics processor etc.) that may perform various appropriate actions and processing based on a program stored in a read-only memory (ROM) 302 or a program loaded from a storage means 305 to a random access memory (RAM) 303. In the RAM 303, there further store various programs and data needed for operations of the electronic device 300. The processing means 301, ROM 302 and RAM 303 are connected to each other via a bus 304. An input/output (I/O) interface 305 is also connected to the bus 304.

Usually, the following devices may be connected to the I/O interface 305: an input device 306 including, for example, a touch screen, a touch pad, a keyboard, a mouse, a camera, a microphone, an accelerometer, a gyroscope, etc.; an output device 307 including, for example, a liquid crystal display (LCD), a speaker, a vibrator, and the like; a storage means 308 including, for example, a magnetic tape, a hard disk, etc.; and a communication means 309. The communication means 309 may allow the electronic device 300 to communicate wirelessly or wired with other devices to exchange data. Although FIG. 4 illustrates an electronic device 300 having multiple devices, it should be understood that not all illustrated devices are required to be implemented or provided. More or fewer devices may alternatively be implemented or provided.

According to embodiments of the present disclosure, the process described above with reference to the flow chart may be implemented as a computer software program. For example, embodiments of the present disclosure include a computer program product comprising a computer program embodied on a computer-readable medium, the computer program containing program code for performing a method of recommending terms. In such an embodiment, the computer program may be downloaded and installed from a network via the communication means 309, or installed from the storage means 305, or installed from the ROM 302. When the computer program is executed by the processing means 301, the above-described functions defined in the method of the embodiment of the present disclosure are performed.

It needs to be appreciated that the computer-readable medium described above in the present disclosure may be either a computer-readable signal medium or a computer-readable storage medium, or any combination of the two. The computer-readable storage medium may be, for example but not limited to, an electronic, magnetic, optical, electromagnetic, infrared, or semiconductor system, apparatus, or device, or a combination of any of the above. More specific examples of the computer-readable storage medium may include, but are not limited to: an electrical connection having one or more conductor wires, a portable computer magnetic disk, a hard disk, a Random Access Memory (RAM), a Read-Only Memory (ROM), an Erasable Programmable Read-Only Memory (EPROM or flash memory), an optical fiber, a Portable Compact Disk Read-Only Memory (CD-ROM), an optical storage means, a magnetic storage means, or any suitable combination of the above. In the present disclosure, a computer-readable storage medium may be any tangible medium that contains or stores a program that may be used by or in connection with an instruction executing system, apparatus, or device. In the present disclosure, the computer-readable signal medium may comprise a data signal embodied in a baseband or propagated as part of a carrier, and carries computer-readable program code. Such propagated data signal may take many forms, including but not limited to, an electromagnetic signal, an optical signal, or any suitable combination of the above. The computer-readable signal medium may also be any computer-readable medium other than a computer-readable storage medium. The computer-readable signal medium may send, propagate, or transmit a program used by or used in combination with the instruction executing system, apparatus, or device. The program code embodied on the computer-readable medium may be transmitted over any suitable medium including, but not limited to: an electric wire, a fiber optic cable, RF (radio frequency), and the like, or any suitable combination of the foregoing. The computer readable storage medium may be a non-transitory computer readable storage medium.

In some embodiments, a client and a server may communicate using any currently known or future-developed network protocol, such as HTTP (Hyper Text Transfer Protocol), and may be interconnected with any form or medium of digital data communication (e.g., a communication network). Examples of the communication network include a local area network (“LAN”), a wide area network (“WAN’), the Internet, and a peer-to-peer network (e.g., an ad hoc peer-to-peer network), as well as any currently known or future-developed network.

The computer readable medium may be contained in the above electronic device; it may also be present separately and not fitted into the electronic device.

The computer-readable medium carries one or more programs that, when executed by the electronic device, cause the electronic device to: obtain an initial mask graph by performing semantic recognition on a target object in an image to be segmented; determine an initial target object area in the image to be segmented based on the initial mask graph; obtain N color classifications of the target object by performing clustering processing on pixel points in the initial target object area according to color values, wherein N is a positive integer greater than or equal to 1; obtain N difference graphs according to the N color classifications and the image to be segmented; determine a target mask graph according to the N difference graphs and the initial mask graph; and segment the target object in the image to be segmented based on the target mask graph.

Computer program code for carrying out operations of the present disclosure may be written in one or more programming languages, including, but not limited to, object oriented programming languages, such as Java, Smalltalk, C++, and conventional procedural programming languages, such as the “C” language or similar programming languages, or a combination thereof. The program code may be executed entirely on the user's computer, executed partly on the user's computer, executed as a stand-alone software package, executed partly on the user's computer and partly on a remote computer, or executed entirely on the remote computer or server. In the case of a remote computer, the remote computer may be connected to the user's computer through any kind of network, including a local area network (LAN) or a wide area network (WAN), or it may be connected to an external computer (e.g., through the Internet using an Internet Service Provider).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The elements described in connection with the embodiments disclosed herein may be implemented in software or hardware. The name of an element does not in any way limit the element itself.

The functions described herein above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), systems on a Chip (SOCs), Complex Programmable Logic Devices (CPLDs), and the like.

In the context of this disclosure, a machine-readable medium may be a tangible medium that may contain or store a program for use by or use in combination with an instruction executing system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of a machine-readable storage medium would include an electrical connection having one or more wires, a portable computer magnetic disk, a hard disk, a Random Access Memory (RAM), a Read-Only Memory (ROM), an Erasable Programmable Read-Only Memory (EPROM or flash memory), an optical fiber, a Portable Compact Disk Read-Only Memory (CD-ROM), an optical storage means, a magnetic storage means, or any suitable combination of the above.

According to one or more embodiments of the present disclosure, embodiments of the present disclosure disclose an object segmentation method comprising:
obtaining an initial mask graph by performing semantic recognition on a target object in an image to be segmented;
determining an initial target object area in the image to be segmented based on the initial mask graph;
obtaining N color classifications of the target object by performing clustering processing on pixel points in the initial target object area according to color values, wherein N is a positive integer greater than or equal to 1;
obtaining N difference graphs according to the N color classifications and the image to be segmented;
determining a target mask graph according to the N difference graphs and the initial mask graph; and
segmenting the target object in the image to be segmented based on the target mask graph

For example, the obtaining the initial mask graph by performing semantic recognition on the target object in the image to be segmented comprises:
inputting the image to be segmented into a target object recognition model, and outputting the initial mask graph.

For example, the determining the initial target object area in the image to be segmented based on the initial mask graph comprises:
obtaining a pixel point in the initial mask graph with a confidence greater than a first set value, and determining the pixel point with the confidence greater than the first set as a first target point;
determining an area formed of pixel points in the image to be segmented corresponding to the first target point as an initial target object area.

For example, the obtaining the N difference graphs according to the N color classifications and the image to be segmented comprises:
obtaining N color average values by calculating average values for the N color classifications respectively;
obtaining the N difference graphs by calculating differences between the image to be segmented and the N color average values respectively.

For example, the determining the target mask graph according to the N difference graphs and the initial mask graph comprises:
adjusting a confidence of a pixel point in the initial mask graph with a confidence falling into a first interval to a first set confidence value, wherein the first interval is greater than the first set value and less than the first set confidence value;
for a pixel point in the initial mask graph with a confidence falling into a second interval, increasing the confidence of the pixel point by a set proportion in response to determining that a color value of the pixel point in the N difference graphs meets a set condition, and decreasing the confidence of the pixel point by the set proportion in response to determining that the color value of the pixel point in the N difference graphs does not meet the set condition, wherein the second interval is greater than a second set value and less than the first set value, and the second set value is less than the first set value; and
adjusting a confidence of a pixel point in the initial mask graph with a confidence falling into a third interval to a second set confidence value, wherein the third interval is greater than the second set confidence value and less than the second set value.

For example, after increasing the confidence of the pixel point by a set proportion, the method further comprises:
setting the pixel point to the first set confidence value in response to determining that the increased confidence exceeds the first set confidence value.

For example, the segmenting the image to be segmented based on the target mask graph comprises:
determining a pixel point in the target mask graph with a confidence being the first set confidence value as a second target point; and
determining an area formed by a pixel point in the image to be segmented corresponding to the second target point as a final target object area.

1. An object segmentation method, comprising:
obtaining an initial mask graph by performing semantic recognition on a target object in an image to be segmented;
determining an initial target object area in the image to be segmented based on the initial mask graph;
obtaining N color classifications of the target object by performing clustering processing on pixel points in the initial target object area according to color values, wherein N is a positive integer greater than or equal to 1;
obtaining N difference graphs according to the N color classifications and the image to be segmented;
determining a target mask graph according to the N difference graphs and the initial mask graph; and
segmenting the target object in the image to be segmented based on the target mask graph.

2. The method according to claim 1, wherein obtaining the initial mask graph by performing semantic recognition on the target object in the image to be segmented comprises:
inputting the image to be segmented into a target object recognition model, and outputting the initial mask graph.

3. The method according to claim 1, wherein determining the initial target object area in the image to be segmented based on the initial mask graph comprises:
obtaining a pixel point in the initial mask graph with a confidence greater than a first set value, and determining the pixel point with the confidence greater than the first set as a first target point; and
determining an area formed of pixel points in the image to be segmented corresponding to the first target point as an initial target object area.

4. The method according to claim 1, wherein obtaining the N difference graphs according to the N color classifications and the image to be segmented comprises:
obtaining N color average values by calculating average values for the N color classifications respectively; and
obtaining the N difference graphs by calculating differences between the image to be segmented and the N color average values respectively.

5. The method according to claim 3, wherein determining the target mask graph according to the N difference graphs and the initial mask graph comprises:
adjusting a confidence of a pixel point in the initial mask graph with a confidence falling into a first interval to a first set confidence value, wherein the first interval is greater than the first set value and less than the first set confidence value;
for a pixel point in the initial mask graph with a confidence falling into a second interval, increasing the confidence of the pixel point by a set proportion in response to determining that a color value of the pixel point in the N difference graphs meets a set condition, and decreasing the confidence of the pixel point by the set proportion in response to determining that the color value of the pixel point in the N difference graphs does not meet the set condition, wherein the second interval is greater than a second set value and less than the first set value, and the second set value is less than the first set value; and
adjusting a confidence of a pixel point in the initial mask graph with a confidence falling into a third interval to a second set confidence value, wherein the third interval is greater than the second set confidence value and less than the second set value.

6. The method according to claim 5, wherein after increasing the confidence of the pixel point by the set proportion, the method further comprises:
setting the pixel point to the first set confidence value in response to determining that the increased confidence exceeds the first set confidence value.

7. The method according to claim 5, wherein segmenting the image to be segmented based on the target mask graph comprises:
determining a pixel point in the target mask graph with a confidence being the first set confidence value as a second target point; and
determining an area formed by a pixel point in the image to be segmented corresponding to the second target point as a final target object area.

8. (canceled)

9. An electronic device, comprising:
one or more processors;
a storage device configured to store one or more programs;
the one or more programs, when executed by the one or more processors, cause the one or more processors to;
obtain an initial mask graph by performing semantic recognition on a target object in an image to be segmented;
determine an initial target object area in the image to be segmented based on the initial mask graph;
obtain N color classifications of the target object by performing clustering processing on pixel points in the initial target object area according to color values, wherein Nis a positive integer greater than or equal to 1;
obtain N difference graphs according to the N color classifications and the image to be segmented;
determine a target mask graph according to the N difference graphs and the initial mask graph; and
segment the target object in the image to be segmented based on the target mask graph.

10. A non-transitory computer-readable medium having stored thereon a computer program which, when executed by a processor, causes the processor to:
obtain an initial mask graph by performing semantic recognition on a target object in an image to be segmented;
determine an initial target object area in the image to be segmented based on the initial mask graph;
obtain N color classifications of the target object by performing clustering processing on pixel points in the initial target object area according to color values, wherein Nis a positive integer greater than or equal to 1;
obtain N difference graphs according to the N color classifications and the image to be segmented;
determine a target mask graph according to the N difference graphs and the initial mask graph; and
segment the target object in the image to be segmented based on the target mask graph.

11. The device according to claim 9, wherein the one or more programs causing the one or more processors to obtain the initial mask graph by performing semantic recognition on the target object in the image to be segmented, further cause the one or more processors to:
input the image to be segmented into a target object recognition model, and output the initial mask graph.

12. The device according to claim 9, wherein the one or more programs causing the one or more processors to determine the initial target object area in the image to be segmented based on the initial mask graph, further cause the one or more processors to:
obtain a pixel point in the initial mask graph with a confidence greater than a first set value, and determine the pixel point with the confidence greater than the first set as a first target point; and
determine an area formed of pixel points in the image to be segmented corresponding to the first target point as an initial target object area.

13. The device according to claim 9, wherein the one or more programs causing the one or more processors to obtain the N difference graphs according to the N color classifications and the image to be segmented, further cause the one or more processors to:
obtain N color average values by calculating average values for the N color classifications respectively; and
obtain the N difference graphs by calculating differences between the image to be segmented and the N color average values respectively.

14. The device according to claim 12, wherein the one or more programs causing the one or more processors to determine the target mask graph according to the N difference graphs and the initial mask graph, further cause the one or more processors to:
adjust a confidence of a pixel point in the initial mask graph with a confidence falling into a first interval to a first set confidence value, wherein the first interval is greater than the first set value and less than the first set confidence value;
for a pixel point in the initial mask graph with a confidence falling into a second interval, increase the confidence of the pixel point by a set proportion in response to determining that a color value of the pixel point in the N difference graphs meets a set condition, and decrease the confidence of the pixel point by the set proportion in response to determining that the color value of the pixel point in the N difference graphs does not meet the set condition, wherein the second interval is greater than a second set value and less than the first set value, and the second set value is less than the first set value; and
adjust a confidence of a pixel point in the initial mask graph with a confidence falling into a third interval to a second set confidence value, wherein the third interval is greater than the second set confidence value and less than the second set value.

15. The device according to claim 14, wherein the one or more programs causing the one or more processors to increase the confidence of the pixel point by the set proportion, further cause the one or more processors to:
set the pixel point to the first set confidence value in response to determining that the increased confidence exceeds the first set confidence value.

16. The device according to claim 14, wherein the one or more programs causing the one or more processors to segment the image to be segmented based on the target mask graph, further cause the one or more processors to:
determine a pixel point in the target mask graph with a confidence being the first set confidence value as a second target point; and
determine an area formed by a pixel point in the image to be segmented corresponding to the second target point as a final target object area.

17. The computer-readable medium according to claim 10, wherein the computer program causing the processor to obtain the initial mask graph by performing semantic recognition on the target object in the image to be segmented, further causes the processor to:
input the image to be segmented into a target object recognition model, and output the initial mask graph.

18. The computer-readable medium according to claim 10, wherein the computer program causing the processor to determine the initial target object area in the image to be segmented based on the initial mask graph, further causes the processor to:
obtain a pixel point in the initial mask graph with a confidence greater than a first set value, and determine the pixel point with the confidence greater than the first set as a first target point; and
determine an area formed of pixel points in the image to be segmented corresponding to the first target point as an initial target object area.

19. The computer-readable medium according to claim 10, wherein the computer program causing the processor to obtain the N difference graphs according to the N color classifications and the image to be segmented, further causes the processor to:
obtain N color average values by calculating average values for the N color classifications respectively; and
obtain the N difference graphs by calculating differences between the image to be segmented and the N color average values respectively.

20. The computer-readable medium according to claim 18, wherein the computer program causing the processor to determine the target mask graph according to the N difference graphs and the initial mask graph, further causes the processor to:
adjust a confidence of a pixel point in the initial mask graph with a confidence falling into a first interval to a first set confidence value, wherein the first interval is greater than the first set value and less than the first set confidence value;
for a pixel point in the initial mask graph with a confidence falling into a second interval, increase the confidence of the pixel point by a set proportion in response to determining that a color value of the pixel point in the N difference graphs meets a set condition, and decrease the confidence of the pixel point by the set proportion in response to determining that the color value of the pixel point in the N difference graphs does not meet the set condition, wherein the second interval is greater than a second set value and less than the first set value, and the second set value is less than the first set value; and
adjust a confidence of a pixel point in the initial mask graph with a confidence falling into a third interval to a second set confidence value, wherein the third interval is greater than the second set confidence value and less than the second set value.

21. The computer-readable medium according to claim 20, wherein the computer program causing the processor to increase the confidence of the pixel point by the set proportion, further causes the processor to:
set the pixel point to the first set confidence value in response to determining that the increased confidence exceeds the first set confidence value.
